(19) United States
(12) Patent Application Publication
(10) Pub. No.: US 2007/0284164 A1
(43) Pub. Date: Dec. 13, 2007

(54) Motor vehicle with electric boost motor

(75) Inventors: George Hamstra, Lemont, IL (US); Mel Gehrs, Downers Grove, IL (US)

Correspondence Address: Welsh & Katz, Ltd.;Jon P. Christensen, 22nd Floor, 120 South Riverside Plaza, Chicago, IL, 60606, US

(73) Assignee: Net Gain Technologies

(21) Appl. No.: 11/804,368

(22) Filed: May 18, 2007

Related U.S. Application Data
(60) Provisional application No. 60/801,813, filed on May 19, 2006.

(51) Int. Cl. B60K 6/00

(52) U.S. Cl. 180/65.2

(57) ABSTRACT

A method and apparatus are provided for operating a motor vehicle having an electric motor and a hydrocarbon fueled engine. The method includes the steps of moving the vehicle using the electric motor and the engine when the vehicle is below a first predetermined speed wherein an instantaneous respective torque contribution of the electric motor and engine is based upon a detected engine load and a vehicle velocity and moving the vehicle using the engine alone when the vehicle is above the first predetermined speed.

### FIELD OF THE INVENTION

The field of the invention relates to motor vehicles and more particularly to motor vehicles with electric drive motors.

### BACKGROUND OF THE INVENTION

Electric motor vehicles and hybrid motor vehicles are known. Each type relies upon an electric drive motor and one or more storage batteries for movement.

Electric motor vehicles are typically used for short distance commuting. Electric vehicles are limited to short distances because of a limited capacity of the storage batteries. After traveling a relatively short distance (e.g., less than 100 miles), the batteries become discharged. If a user does not monitor a state of charge of the batteries, the user may become stranded and/or the batteries may become damaged.

The electric motor in such vehicles may be directly connected to a drive shaft or to a transmission. Speed is controlled by varying a field current or by pulse width modulating current to the motor.

In addition to an electric motor and batteries, hybrid motor vehicles also include an internal combustion engine (ICE). The ICE may be coupled to a generator/alternator as a backup power source for the batteries. A controller within the hybrid vehicle may monitor a charge status of the batteries. Whenever the charge status reaches a certain level of discharge, the controller activates the ICE to recharge the batteries. Once the batteries have been recharged, the controller may again deactivate the ICE.

The use of electric and hybrid vehicles can have a significant impact on reducing fuel consumption, greenhouse gases and air pollution. For short trips, both types of vehicle can be expected to operate entirely on battery power. When the user returns home, the batteries may be recharged from an electric outlet.

While electric and hybrid vehicles can have a significant impact on the environment, there are applications where existing technology is not adequate or is too expensive. Examples include large passenger vehicles and trucks. Because of the importance of the environment, a need exists for better ways of reducing emissions from such vehicles.

### SUMMARY

A method and apparatus are provided for operating a motor vehicle having an electric motor and a hydrocarbon fueled engine. The method includes the steps of moving the vehicle using the electric motor and the engine when the vehicle is below a first predetermined speed wherein an instantaneous respective torque contribution of the electric motor and engine is based upon a detected engine load and a vehicle velocity and moving the vehicle using the engine alone when the vehicle is above the first predetermined speed.

In another aspect, the predetermined speed is greater than 30 miles per hour.

In another aspect, a speed of the vehicle is detected and the motor deactivated when the speed exceeds the first predetermined speed.

In another aspect, the vehicle is moved by the engine from a standing stop to a second predetermined speed to eliminate electric motor stall current.

In another aspect, the second predetermined speed is less than one mile per hour.

In another aspect, an electric motor control signal is determined by summing a set of values including the measured speed, a throttle position and an engine load and scaling the summed set of values.

In another aspect, the set of values is retrieved from a preexisting on-board diagnostics connector of the vehicle engine.

In another aspect, the electric motor is disabled based upon a condition of vehicle backup, braking, low battery voltage, high electric motor current, high electric motor temperature or high motor controller temperature.

In another aspect, a user is allowed to configure a maximum allowable electric motor current.

In another aspect, a plurality of electric motor and engine parameters are retrieved and stored on a removable memory card.

In another aspect, the step of moving the vehicle using a combination of the electric motor and the engine includes adjusting the relative contribution of electric motor torque and engine output or torque to optimize gas mileage.

In another aspect, the engine load is detected through a preexisting on-board diagnostic computer connection.

In another aspect, a rotor of the electric motor is integrated with a drive shaft of the vehicle.

In another aspect, the rotor is enclosed with a stator and the stator is rotatably supported on opposing ends by the drive shaft.

In another aspect, a coupler is connected between the stator and a body of the hybrid vehicle to prevent rotation of the stator relative to the body.

### BRIEF DESCRIPTION OF THE DRAWINGS

FIG. 1 is a cut-away side view of an electrically assisted motor vehicle shown generally in accordance with an illustrated embodiment of the invention;

FIGS. 2a-b are a cut-away side and front views of an electrical motor used in the vehicle of FIG. 1; and

FIG. 3 is a block diagram of the electrical drive system of the vehicle of FIG. 1.

### DETAILED DESCRIPTION OF AN ILLUSTRATED EMBODIMENT

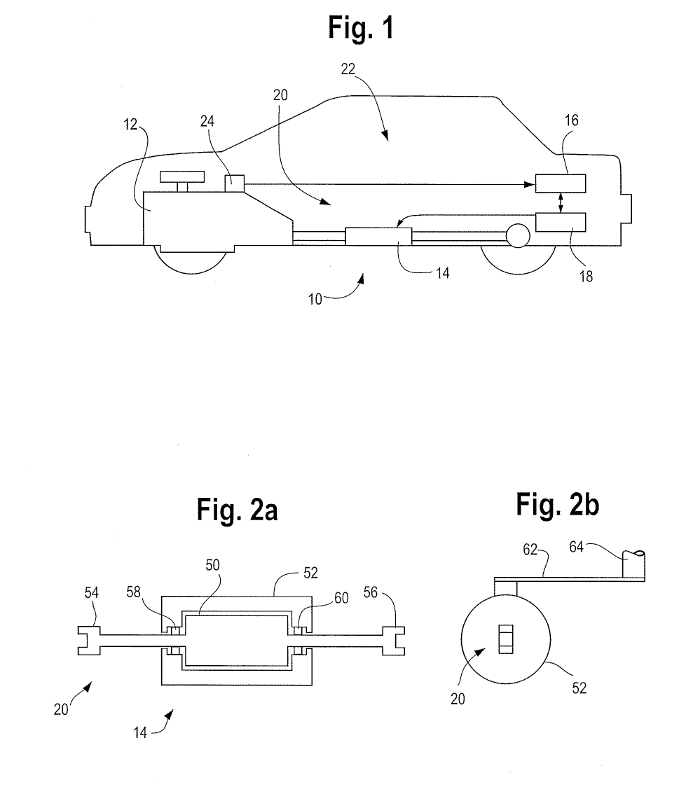

FIG. 1 is a cut-way view of a motor vehicle 10 shown generally in accordance with an illustrated embodiment of the invention. Included within the vehicle 10 is a hydrocarbon fueled, ICE 12 that provides the primary power source for moving the vehicle 10 through torque applied to the drive wheels of the motor vehicle 10 through a drive shaft 20.

Included within the vehicle 10 is an electric drive system 22 that provides auxiliary or boost torque to the drive wheels of the motor vehicle 10. The electric drive system 22 includes an electric motor 14, one or more batteries 18 and a power controller 16 that controls application of power from the batteries 18 to the motor 14.

The electric drive system 22 provides mechanical power to the drive wheels to help move the vehicle 10 under a limited predetermined set of operating conditions. An instantaneous respective torque of the electric motor 14 and ICE 12 may be based upon a detected engine load and a vehicle velocity or upon engine load, vehicle velocity and absolute throttle position. The relative torque contribution of the electric motor 14 and ICE 12 may be adjusted based upon the characteristics of the ICE 12 to optimize fuel economy.

For example, it has been found that the ICE 12 is very fuel inefficient below 30 mph. In stop and go driving, the application of mechanical power from the electric motor 14 to help move the vehicle 10 has been found to significantly improve the fuel economy of the vehicle 10. The use of the electric drive system 22 has been found to reduce fuel consumption by up to 26%.

The electric drive system 22 can be installed in new vehicles 10 or retrofitted to preexisting vehicles 10. Whether installed on new or preexisting vehicles 10, the electric drive system 22 may be controlled via a set of signals obtained through an On Board Diagnostic (OBD) connector 24. The OBD connector 24 is a preexisting data port provided by the manufacturer of the vehicle 10 that is otherwise intended for diagnosis of engine behavior. Signals received from the OBD connector 24 may include an absolute throttle position (ATP), engine load (i.e., percent of requested engine power (hereinafter “LOAD”)), vehicle speed (VS), engine RPMs and engine mass air flow. Other signals derived from the vehicle may include a signal indicating that the transmission of the vehicle 10 is in reverse and a signal indicating that brakes have been activated. In the case of the transmission being in reverse and braking, the signal may be obtained from the respective backup and brake lights.

At least some of the signals (e.g., ATP, VS, LOAD) may be provided within a range of from 0 to 100. If not, then these values may be normalized accordingly.

Under a first preferred embodiment, the electric motor 14 is integrated with the drive shaft 20 and is coaxial with the drive shaft 20. FIG. 2a is a cut-away side view of a motor 14 and drive shaft 20 under the first embodiment and FIG. 2b is an end view.

Under the first embodiment, a rotor 50 of the electric motor 14 is integral with the drive shaft 20 of the hybrid vehicle 10. Stated another way, the rotor 50 forms a portion of the drive shaft 20. One way to conceptualize the rotor under a first embodiment is to imagine the laminations of the rotor being provided in the form of a clam shell that is clamped (e.g., bolted) around an outer periphery of the drive shaft 20. Under other embodiments, the rotor may be thought of as being conventional except that it has exceptionally long shafts extending from one or both ends and a U-joint coupler and/or spline 54, 56 disposed on each end. The U-joint or spline 56 on one end of the rotor/drive shaft 20 is coupled to the differential and the U-joint or spline 54 on the other end is coupled to the transmission.

The stator 52 of the electric motor encloses the rotor and is rotatably supported on opposing ends by the drive shaft 20. A set of bearings 58, 60 on opposing ends of the stator directly support the stator 52 from the drive shaft 20.

A coupler 62 is connected between the stator 52 and a body 64 of the vehicle. The coupler 62 prevents rotation of the stator 52 relative to the body 64. If the coupler 62 were to be removed, the stator 52 would be supported entirely by the drive shaft 20 through the bearings 58, 60 and would rotate freely.

The coupler 62 may be provided as a flexible bar or a set of cables. Cables are preferred because the motor/drive shaft combination 14, 20 would be expected to have at least some movement relative to the body 64 of the vehicle.

In the case where the electric drive system 22 is retrofitted to an existing vehicle, the motor 14 may be installed by removing the existing drive shaft and replacing the original drive shaft with the motor/drive shaft combination 14, 20 shown in FIGS. 2a-b.

Under a second preferred embodiment, the motor 14 may be offset from the centerline of the drive shaft 20 (e.g., the motor 14 and drive shaft 20 may be installed side-by-side, parallel to each other, but laterally offset, one from another). Under this second embodiment, drive shaft 20 is connected to the motor 14 via a belt or drive chain that passes over a belt sheave or sprocket mounted around the drive shaft 20 and a corresponding belt sheave or sprocket mounted on the motor 14.

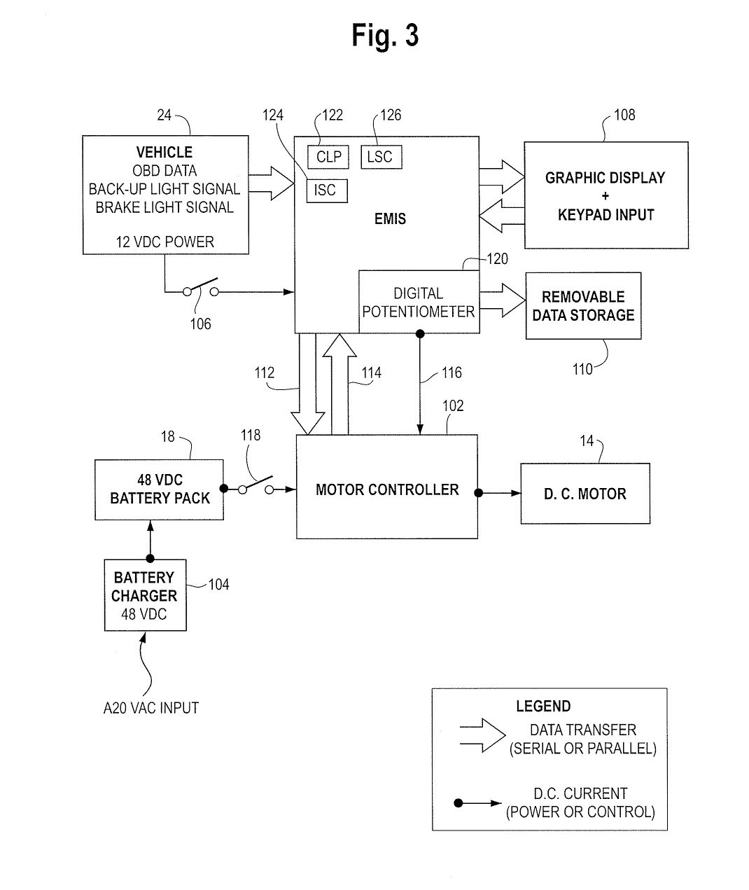

Turning now to the controller 16, an explanation will be provided of the structure and operation of the controller 16. FIG. 3 is a block diagram of the electric drive system 22. As shown, the batteries 18 may include four 12 volt batteries connected in series to provide a total voltage output of 48 volts. A battery disconnect 118 may be provided for safety purposes. The vehicle 10 may also include a battery charger 104 for charging the batteries 18 from the power grid when the vehicle 10 is parked near an outlet, although battery charging could also occur from an alternator of the ICE 12.

The controller 16 includes a processor 100 and a power controller or modulator 102. The power controller 102 may be an Alltrax model number 7245, rated at 72 volts and 450 amperes. The Alltrax power controller operates by pulse width modulating the battery voltage applied to the motor 14 under the control of a 0-1 volt input control signal 116 provided by the processor 100.

The power controller 102 may allow the processor 100 to read any of a number of operating parameters of the power controller 102. This may be accomplished by the processor 100 transferring a selection instruction to the power controller 102 through a control bus 112. A value of the operating parameter may be returned through a second serial or parallel bus 114. Operating parameters that may be read through the bus 114 may include battery voltage, an instantaneous motor current and a temperature of the power transistors of the power controller 102.

The power controller 102 may operate over a number of current ranges selectable within the processor 100. Current ranges selectable through the bus 112 include a 150 amp range, a 300 amp range and a 450 amp range.

The operating mode of the processor 100 may be selected and displayed via a graphic display and keypad input 108. A user may also use the graphic display and keypad input 108 to select and store motor and ICE parameters on a removable data storage (memory card) 110. Alternatively, a set of operating parameters may be presented for use by the drive system 22 from the removable data storage 110.

The controller 100 may receive 12 volt power upon activation of the ignition switch 106. As the user places the vehicle 10 in gear and depresses the accelerator pedal, the processor 100 may begin applying power to the motor 14 based upon ICE parameters retrieved through the OBD connector 24. In this regard, a current level processor 122 within the processor 100 may retrieve values of ATP, VS and LOAD from the OBD connector 24 and begin calculating a desired current level to be applied to the motor 14 based upon the retrieved parameters. For example, if the processor 100 is in the 150 amp mode, then the current level processor 122 may begin applying a 0.0 to 1.0 volt control signal to the power controller 102 determined by evaluating the expression (ATP+VS+LOAD)/250. Similarly, if the processor 100 is in the 300 amp mode, then the current level processor 122 modulates the power controller 102 by evaluating the expression (ATP+VS+LOAD)/135. Alternatively, if the processor 100 is in the 450 amp mode, then the current level processor 122 modulates the power controller 102 by evaluating the expression (ATP+VS+LOAD)/65.

The processor 100 may evaluate the data received from the OBD connection and apply or not apply power to the motor 14 based upon a predetermined set of operating conditions. For example, under one preferred embodiment, an intermediate speed comparator 124 within the processor 100 compares VS with a first predetermined speed and discontinues current to the motor 14 when the speed of the vehicle 10 exceeds 45 mph. Under an even more preferred embodiment, the intermediate speed comparator 124 discontinues power boost via the motor 14 when the speed of the vehicle 10 exceeds 30 mph.

The selection of the speed at which power boost is discontinued is determined by the operating characteristics of the ICE 12 of the vehicle 10. For example, it has been found that above 30 mph at least some ICEs 12 enter an operating mode of significantly improved fuel efficiency. In other vehicles 10, the improved operating mode is above 45 mph. In either case, once the vehicle 10 exceeds the predetermined speed of improved efficiency, the intermediate speed comparator 124 reduces the signal 116 substantially to 0.0 volts thereby deactivating the motor 14.

The processor 100 may also delay application of power to the motor 14 from a standing start to reduce the locked rotor current to the motor 14 to thereby avoid the possibility of damage to the commutator or other motor components. In this case, a low speed comparator 126 compares VS with a low speed threshold. Under one preferred embodiment, the low speed comparator 126 causes the processor 100 to begin applying electric or torque boost above 1 mph. Under another preferred embodiment the processor 100 begins to apply electric or torque boost above 2 mph.

The processor 100 may also discontinue power to the motor 14 under a number of other conditions. For example, power to the motor 14 is discontinued when a backup or brake activation signal is detected. The processor 100 may also discontinue power to the motor 14 when the ATP or LOAD is less than 2% of maximum value.

Other conditions where the processor 100 deactivates the motor 14 include an interlock time out. In this case, the OBD 24 periodically provides signals regarding vehicle status. If any signal is not updated for a predetermined minimum time period, the processor 100 deactivates the motor 14. Similarly, if the data response from the controller 102 to the processor 100 is not updated for a predetermined minimum period, the processor 100 deactivates the motor 14. Similarly, if battery voltage is too low or current to the motor exceeds the settable value of 150, 300 or 450 amps or the temperature of components within the power controller 102 is too high, the processor 100 deactivates the motor 14.

The electric drive system 22 offers tremendous advantage not only in improved fuel economy, but also in reduced vehicle emissions and reduced wear and tear on the engine and transmission of the vehicle 10.

Additional advantages also accrue based upon the ease of use of the vehicle 10 and the ability to retrofit the system 22 to existing vehicles. Conversion of an existing vehicles under the first embodiment involves the simple replacement of the drive shaft with the motor/drive shaft combination 14, 20 and plugging a connector of the system 22 into the OBD connector 24. The batteries and controller 16 may be placed in the trunk.

Moreover, there is no user training required. Since the system 22 operates based upon signals received through the OBD 24 and elsewhere on the vehicle, the operation of the system 22 is entirely transparent to the user.

A specific embodiment of method and apparatus for moving a motor vehicle have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of operating a motor vehicle having an electric motor and a hydrocarbon fueled engine comprising:
moving the vehicle using the electric motor and the engine when the vehicle is below a first predetermined speed wherein an instantaneous torque contribution of the electric motor is based upon a detected engine load and a vehicle velocity; and
moving the vehicle using the engine alone when the vehicle is above the first predetermined speed.

2. The method as in claim 1 wherein the predetermined speed further comprises a speed greater than 30 miles per hour.

3. The method as in claim 1 further comprising measuring a speed of the vehicle and deactivating the motor when the speed exceeds the first predetermined speed.

4. The method as in claim 3 further comprising moving the vehicle using the engine from a standing stop to a second predetermined speed to eliminate electric motor stall current.

5. The method as in claim 4 wherein the second predetermined speed further comprises less than one mile per hour.

6. The method as in claim 5 further comprising determining an electric motor control signal by summing a set of values including the measured speed, a throttle position and an engine load and scaling the summed set of values.

7. The method as in claim 6 further comprising retrieving the set of values from a preexisting on-board diagnostics connector on the motor vehicle.

8. The method as in claim 1 further comprising disabling the electric motor based upon a condition of vehicle backup, brake, low battery voltage, high electric motor current, high electric motor temperature or high motor controller temperature.

9. The method as in claim 1 further comprising a user configuring a maximum allowable electric motor current.

10. The method as in claim 1 further comprising retrieving a plurality of electric motor and engine parameters and storing the plurality of parameters on a removable memory card.

11. The method as in claim 1 wherein the step of moving the vehicle using a combination of the electric motor and the engine further comprises adjusting the relative contribution of electric motor torque and engine output or torque to optimize gas mileage.

12. The method as in claim 1 further comprising detecting the engine load through a preexisting on-board diagnostic computer connection.

13. The method as in claim 1 further comprising integrating a rotor of the electric motor with a drive shaft of the hybrid vehicle.

14. The method as in claim 13 further comprising enclosing the rotor with a stator of the electric motor and rotatably supporting the stator on opposing ends with the drive shaft.

15. The method as in claim 14 further comprising connecting a coupler between the stator and a body of the hybrid vehicle to prevents rotation of the stator relative to the body.

16. A method of operating a motor vehicle having an electric motor and a hydrocarbon fueled engine comprising:
moving the vehicle using the electric motor and the engine when the vehicle is below a first predetermined speed wherein an instantaneous torque contribution of the electric motor is based upon a set of engine parameters received through an OBD connector; and
moving the vehicle using the engine alone when the vehicle is above the first predetermined speed.

17. The method as in claim 16 wherein the predetermined set of engine parameters further comprise absolute throttle position.

18. The method as in claim 16 wherein the predetermined set of engine parameters further comprise engine load.

19. The method as in claim 16 wherein the predetermined set of engine parameters further comprise vehicle speed.

20. The method as in claim 16 wherein the predetermined speed further comprises a speed greater than 30 miles per hour.

21. The method as in claim 16 further comprising measuring a speed of the vehicle and deactivating the motor when the speed exceeds the first predetermined speed.

22. The method as in claim 16 further comprising determining an electric motor control signal by summing a set of values including the measured speed, a throttle position and an engine load and scaling the summed set of values.

23. The method as in claim 16 further comprising determining a status of the vehicle braking or reverse gear from existing vehicle signal functions.

24. An apparatus for operating a motor vehicle having an electric motor and a hydrocarbon fueled engine comprising:
an OBD connector that provides a plurality of operating parameters of an engine of the vehicle;
the electric motor coupled to a drive shaft of the vehicle; and
a processor that applies power to the electric motor when the vehicle is below a first predetermined speed, wherein an instantaneous torque contribution of the electric motor is based upon the plurality of operating parameters and wherein the processor deactivates the electric motor when the vehicle is above the first predetermined speed.

25. The apparatus of claim 24 wherein the predetermined speed further comprises a speed greater than 30 miles per hour.

26. The apparatus of claim 24 further comprising determining an electric motor control signal by summing a set of values including the measured speed, an absolute throttle position and an engine load and scaling the summed set of values.

27. The apparatus of claim 24 wherein the processor deactivates the electric motor based upon a presence of an indicator signal from a vehicle brake light.

28. The apparatus of claim 24 wherein the processor deactivates the electric motor based upon a detection of an indicator signal from a vehicle reverse light.

29. The apparatus of claim 24 further comprising a rotor of the electric motor integral with a drive shaft of the hybrid vehicle.

30. The apparatus of claim 29 further comprising a stator that encloses the rotor and is rotatably supported on opposing ends by the drive shaft.

31. The apparatus of claim 30 further comprising a coupler connected between the stator and a body of the hybrid vehicle to prevent rotation of the stator relative to the body.

32. A motor vehicle having an electric motor and a hydrocarbon fueled engine comprising:
a rotor of the electric motor that is integral with a drive shaft of the vehicle;
a stator of the electric motor enclosing the rotor and rotatably supported on opposing ends by the drive shaft; and
a coupler connected between the stator and a body of the vehicle that prevents rotation of the stator relative to the body.

33. The motor vehicle as in claim 32 wherein a rotor of the electric motor is clamped around the drive shaft.
